(19) United States
(12) Patent Application Publication
(10) Pub. No.: US 2016/0101473 A1
(43) Pub. Date: Apr. 14, 2016

(54) Adjustable LED Puck Light Drill Jig

(71) Applicant: Tad K. Lostlen, Morongo Valley, CA (US)

(72) Inventor: Tad K. Lostlen, Morongo Valley, CA (US)

(21) Appl. No.: 14/852,839

(22) Filed: Sep. 14, 2015

Related U.S. Application Data
(60) Provisional application No. 62/061,272, filed on Oct. 8, 2014.

(51) Int. Cl. B23B 47/28

(52) U.S. Cl. CPC B23B 47/287; B23B 2247/08

(57) ABSTRACT

Improvements in a LED puck light drill jig is disclosed. The adjustable LED puck light drill jig is adjustable to be consistent and repeatable. The jig has a location for drilling a recessed hole for a puck light at a fixed depth to allow the puck light to be recessed in a wall or shelf. An orthogonal drill guide is pre-aligned with the hole for the puck light. The drill guide is further aligned with the centerline of the wall or shelf to provide a maximum amount of material on both sides of the wall or shelf. The drill guide has a relief for removed material to be expelled rather than transporting the material to the extreme end of the drill guide.

### CROSS REFERENCE TO RELATED APPLICATIONS

This application is a continuation-in-part of applicant's co-pending application Ser. No. 62/061,272 filed Oct. 8, 2014 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the invention

This invention relates to improvements in a drill jig for installing puck lights. More particularly, the present drill jig provides a complete solution for drilling a hole for a puck light and drilling a parallel hole in the shelf or wall for routing wiring to the puck light hole.

2. Description of Related Art Including Information Disclosed Under 37 CFR 1.97 and 1.98.

Installing lighting under cabinets can take a variety of different types. Puck lights are one typical type of lighting. Installing the lighting requires that the puck light is placed on the surface of the wall or shelf where the wiring is exposed on the outer surface of the wall or shelf. Another method is to place the puck light of one side of the shelf or wall and place a hole through the wall or shelf where the wiring is placed on the back side of the wall or shelf. In both of these cases exposed wiring is on an outer surface of the cabinet. Because each installation is unique for the location of the puck light on the wall or shelf the only way to conceal wiring in a shelf or cabinet requires a hole to be drilled parallel to the thickness of the shelf or wall.

There have been some drilling jigs or guides for placing one or more holes through doors or shelves, but these do not provide adjustments for placing the holes for puck lighting at nearly any location on a wall or shelf. A number of patents and or publications have been made to address these issues. Exemplary examples of patents and or publication that try to address this /these problem(s) are identified and discussed below.

U.S. Pat. No. 2,798,520 issued on Jul. 9, 1957 to J. M. Maskulka et al., discloses a Drill Guide. This drill guide has a plurality of cylindrical passageways for drilling two parallel holes. The parallel holes allow for insertion of dowels for securing corners of a picture frame. While this patent provides a drill guide, there are no adjustments on the drill guide for the dimensions between the drilled holes and further does not allow for drilling the two holes orthogonal to each other.

U.S. Pat. No. 6,910,837 issued on Jun. 28, 2005 to David J. Trettin et al discloses a Lockset Drilling Guide. The drilling guide provides for drilling two orthogonal holes for insertion of a door knob and latch mechanism. There are no adjustments for the dimensions between the two holes, and the two holes are used with circular saws to make the holes. Because door locksets have the same geometry the only adjustment is how for the holes are made from one end of the door. The hole for the door knobs are through holes and do not include a method to drill a finite depth for insertion of a puck light into a recessed hole.

U.S. Pat. No. 7,073,990 issued on Jul. 11, 2006 to Ursula Poeckl discloses a Dowel Gauge. The dowel gauge has a single drill guide hole with indicia for moving the single drill guide for drilling additional holes at the same distance apart. The dowel gauge in re-positioned to drill opposing holes for the dowel holes. While this provides a drill guide it does not include a guide for drilling a recessed hole for insertion of a light puck.

What is needed is a drill jig that allows an installer to drill a recessed hole and an orthogonal hole for wiring. The proposed adjustable LED puck light drill jig provides the solution with an adjustable jig where puck light can be repeatedly placed at a desired location in a wall of shelf.

### BRIEF SUMMARY OF THE INVENTION

It is an object of the adjustable LED puck light drill jig to allow for drilling a hole for a LED puck light. The drilling of the hole for the puck light is made to a finite depth into the wall or shelf. The finite depth allows the puck light to be recessed into the wall or shelf without protruding into the other side of the wall or shelf and also reduces the amount of exposure of the puck light. A stop of a forstner or similar hole drilling bit is used to create a round hole with a flat smooth finished bottom surface where the LED puck light is inserted.

It is an object of the adjustable LED puck light drill jig to drill a hole parallel to the surface of a wall or shelf. The drill guide is pre-aligned with the hole for the puck light. The drill guide is further aligned with the centerline of the wall or shelf to provide a maximum amount of material on both sides of the wall or shelf. An installer drills the hole through to the hole created for the puck light. Wiring can then be placed through this parallel hole to provide electricity to an installed puck light.

It is another object of the adjustable LED puck light drill jig to be adjustable to distance from the back of the wall or shelf. Each installation can be located a different distance from a front or back side and can include multiple puck lights spaced along a shelf, wall or ceiling. Often the location is dictated by a customer or lighting requirements. The depth of the shelf or wall can also be a variable. The drill jig has adjustments so the dimensions between multiple pick lights is consistent and repeatable.

It is still another object of the adjustable LED puck light drill jig to have a chip relief area to clear material that has been removed by the drill. Because the length of the drill guide can be long to ensure that the drill passes parallel to the sides of the shelf, wall or side of cabinet, material that is removed from the drill must be transported from the tip of the drill to a location outside of the drill guide. The drill guide has a relief for removed material to be expelled rather than transporting the material to the extreme end of the drill guide.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a bottom perspective view of an adjustable LED puck light drill jig.

FIG. 2 shows a top perspective view of the adjustable LED puck light drill jig.

FIG. 3 shows a top perspective view of the adjustable LED puck light drill jig in a cabinet wall or shelf.

FIG. 4 shows a top perspective view of the adjustable LED puck light drill jig clamped on a shelf.

FIG. 5A shows a cutter for a puck light with a depth stop.

FIG. 5B shows the cutter for the cutter for a puck light with the depth being adjusted.

FIG. 6 shows a perspective view of the hole being cut for the puck light.

FIG. 7 shows a perspective view of a side hole being drilled to route wiring to the puck light opening.

FIG. 8 shows the side hole drill entering the puck light recess hole.

FIG. 9 shows a perspective view of a second preferred embodiment of the adjustable LED puck light drill jig.

FIG. 10 shows a perspective view of a third preferred embodiment of the adjustable LED puck light drill jig.

### DETAILED DESCRIPTION OF THE INVENTION

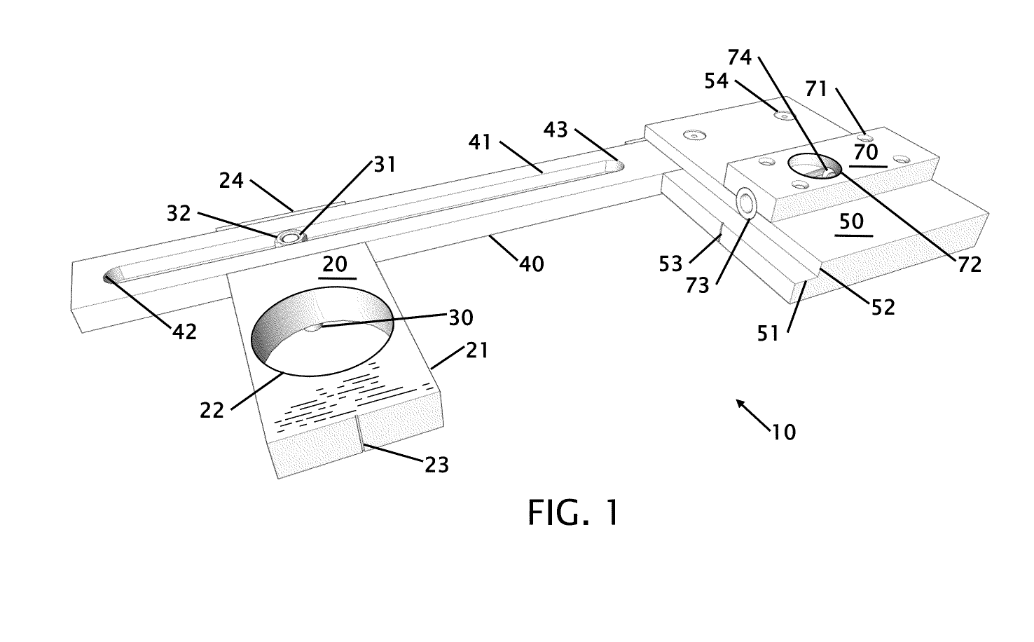

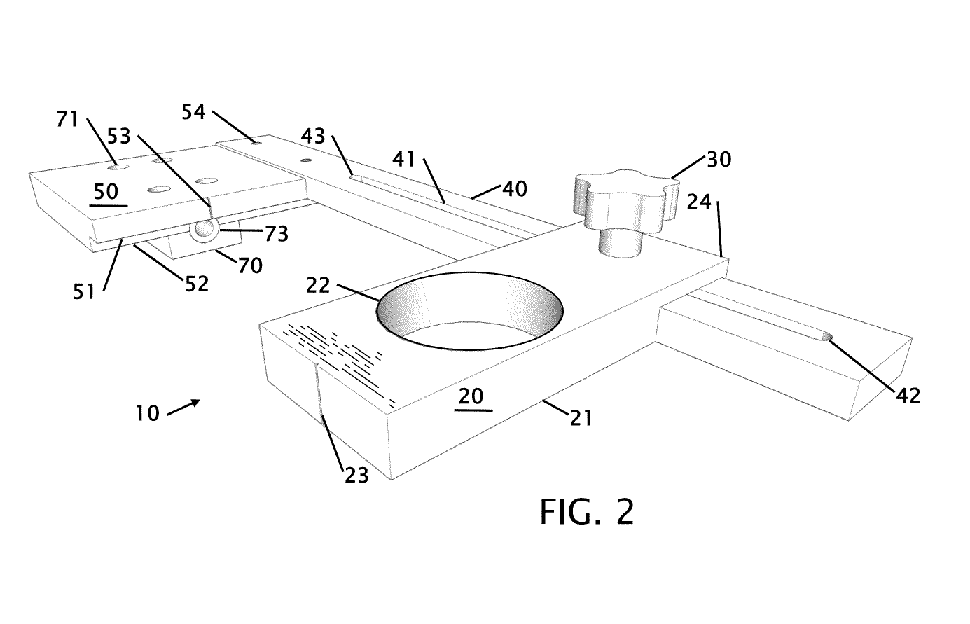

FIG. 1 shows a bottom perspective view of an adjustable LED puck light drill jig 10 and FIG. 2 shows a top perspective view of the adjustable LED puck light drill jig 10. The adjustable LED puck light drill jig 10 has a first hole guide 20 for drilling the recess for the puck light. The hole guide 20 has a central hole 22. The hole guide 20 is essentially rectangular is shape with vertical side walls 21. On one or more sides of the hole guide body 20 a notch 23 or other indicia identifies the centerline of the hole 22. This allows an installer to align the adjustable LED puck light drill jig 10 to a mark for locating the central hole 22 for the LED puck light. The body of the hole guide 20 wraps around a guide rail 40 and a portion 24 of the body of the hole guide 20 is visible on the other side of the guide rail 40.

The hole guide 20 is secured to the guide rail 40 with a nut 32 that is retained on one side of the guide rail 40 and a bolt 31 connected to a tightening knob 30 or handle that is turned to pull the nut 32 and clamp or sandwich the hole guide 20 to the guide rail 40. The guide rail 40 is an elongated member with an elongated slot 41 that runs parallel to the sides of the guide rail 40. The elongated slot 41 allows the hole guide 20 to be moved along the guide rail 40 to a desired distance from an edge of a shelf wall or cabinet. The location of the hole 20 can be moved and located to any position between either of two extreme ends 42 and 43 of the guide rail 40. At one end of the guide rail 40 is a fixed guide 50 for drilling an elongated hole for to route wire to a recessed hole for a puck light that is drilled at hole 22.

The fixed guide 50 has a rectangular plate with a step having a surface 51 that is placed on the parallel surface of a shelf or cabinet where the puck light will be installed, and a vertical wall 52, step or stop for locating the edge of the cabinet or shelf. A mark or indicia 53 identifies the centerline for drilling the wiring hole. A plurality of securing hardware members 54 secure the bottom plate 50 to the guide rail 40.

A top plate 70 is secured to the rectangular plate. Two drill guides 73 and 74 are located between the bottom plate 50 and the top plate 70. Securing hardware 71 secures the top plate 70 to the bottom plate 50. The securing hardware 71 allows the bottom plate 50 and the top plate 70 to be separated to replace the drill guides 73 and 74. The top plate 70 has a clearance opening 72 for chips to be expelled from between the two drill guides 73 and 74. The clearance opening 72 create a shorter path for removed (drilled) wood to be ejected before being transferred down the entire length of both drill guides.

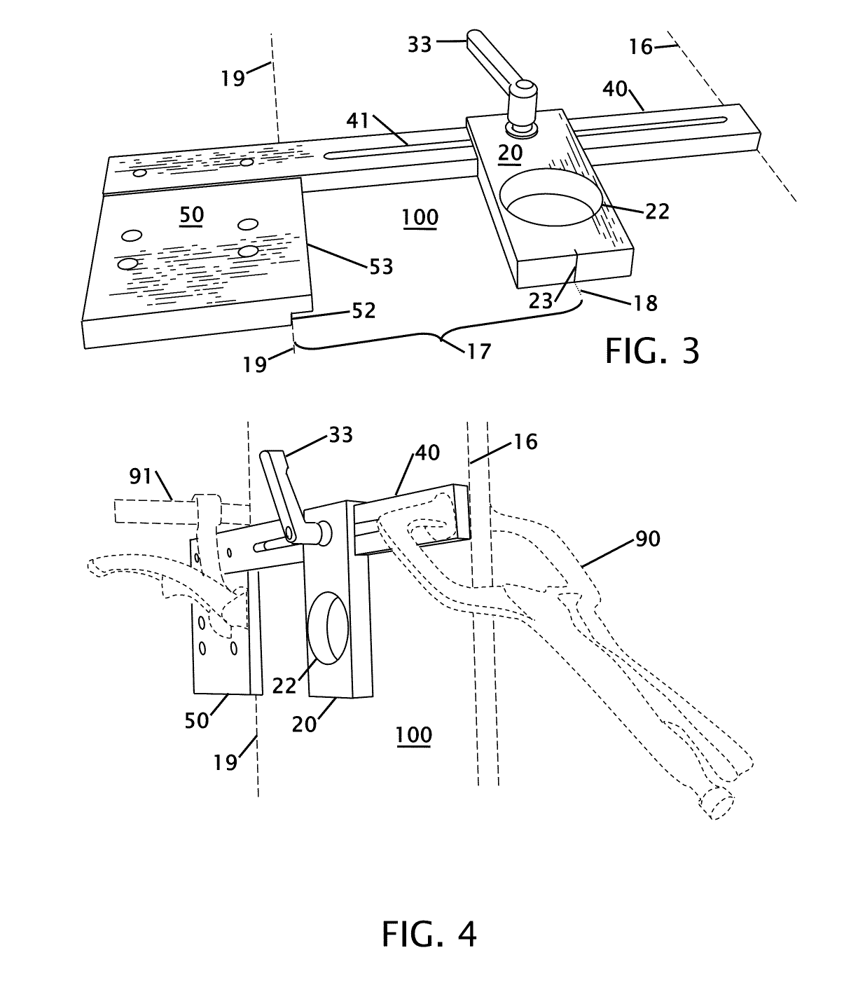

FIG. 3 shows a top perspective view of the adjustable LED puck light drill jig 10 in a cabinet wall or shelf and FIG. 4 shows a top perspective view of the adjustable LED puck light drill jig 10 clamped on a shelf. When using the adjustable LED puck light drill jig 10, the step edge surface 52 of the bottom plate 50 is brought against an edge 19 of the shelf or cabinet 100. The adjustable LED puck light drill jig 10 is constructed in a length so the end of the guide rail 40 aligns with the far end of the cabinet or shelf 16. While a particular length of the adjustable LED puck light drill jig 10 is shown, the length of the guide rail 40 can be fabricated in various lengths to match different size shelves or cabinets.

The bottom plate 50 is aligned with the centerline 53 where the puck light will be placed. The marking location on the cabinet or shelf 100 can be pre-placed on the cabinet or shelf 100 for placement of the puck light. The handle 33 is loosened to set the location of the hole 22 along the length of the guide rail 40. A mark 18 on the surface of the cabinet or shelf 100 is aligned with the mark or indicia 23 on the hole guide 20. This adjustment sets the dimension 17 between the edge of the cabinet or shelf 100 and where the recessed hole 22 will be placed. The handle 33 (or a knob as previously shown) is tightened to lock the location of the hole guide 20 in the elongated slot 41 in the guide rail 40. Once the dimensions are set, the adjustable LED puck light drill jig 10 is clamped onto the shelf or cabinet with clamps 90 and 91 at opposing sides of the adjustable LED puck light drill jig 10.

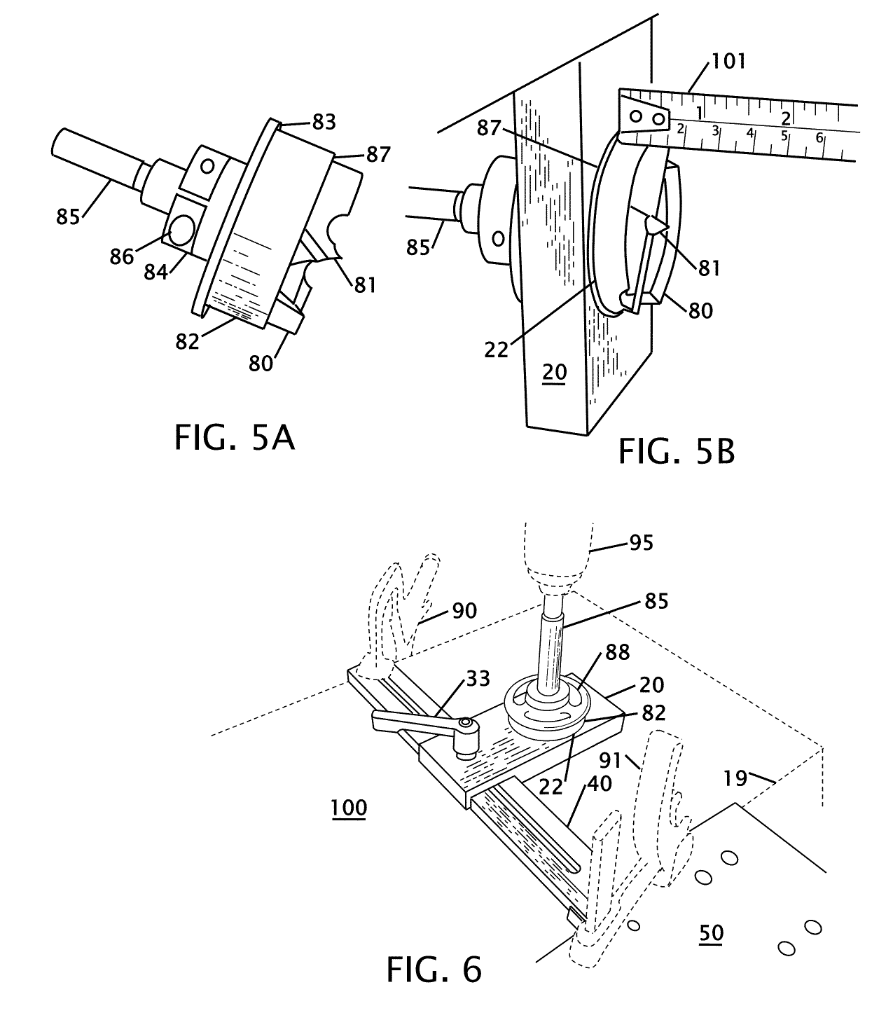

FIG. 5A shows a cutter for a puck light with a depth stop and FIG. 5B shows the cutter for the cutter for a puck light with the depth being adjusted. The recessed hole is cut with a forstner or equivalent type drill. The drill has a tip 81 that creates a center guide for holding the drill or cutter in the center of the hole. One or a plurality of blades 80 cuts and clears the recessed hole. The forstner drill is placed in a guide stop having an outer guide surface 82 with a stop lip 83 that prevents the forstner drill from being pushed too far into the cabinet or shelf. The guide 82 is essentially the same dimension as the thickness of the hole guide 20 to allow the bottom lip 87 of the stop to be flush with the cabinet of shelf surface. The diameter of the guide 82 is also essentially the same as the dimension as the central hole 22 in the hole guide 20. If a larger diameter forster drill is used the side of the guide 82 may be thinner or removed. The drill guide has a vertical circular clamp 84 that is secured 86 to the shank 85 of the forstner drill.

The securing mechanism 86 is loosened to move the guide on the forstner drill to achieve the desired recess depth 101. The guide can then be tightened to set the depth of the recess that will be drilled or cut into the shelf or cabinet. The top of the guide has openings 88 for removal of chips or sawdust as the recess is cut. The openings 88 are shown in FIG. 6.

FIG. 6 shows a perspective view of the hole being cut for the puck light. The adjustable LED puck light drill jig 10 is shown secured to the cabinet or shelf 100 with clamps 90 and 91 on the edge 19 of the cabinet or shelf. The bottom plate 50 is shown secured to the guide rail 40. The guide rail is secured with handle 33 clamping the hole guide 20 to the guide rail 40. The central hole 22 has the guide 82 secured on the forstner drill shank 85 secured in drill 95 to cut a counterbore recessed hole with an essentially flat bottom. Clearance holes 88 allow removed material to clear through the forstner drill and the guide 82. After the recessed hole is drilled the side hole for routing the electricity to the puck light can be drilled.

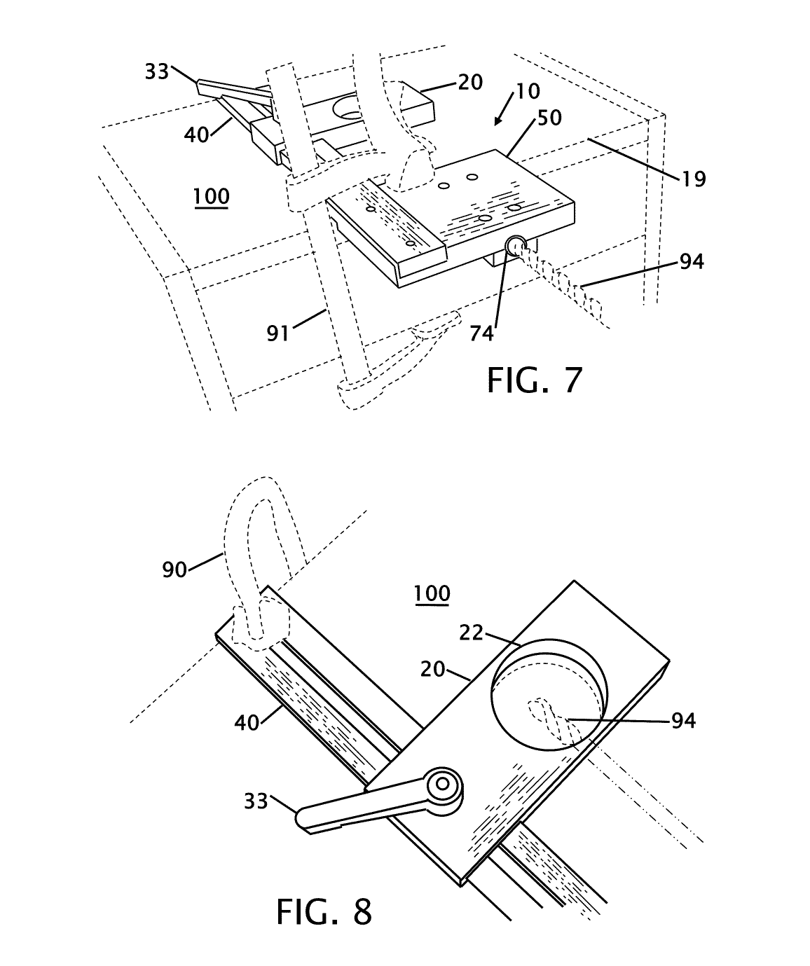

FIG. 7 shows a perspective view of a side hole being drilled to route wiring to the puck light opening and FIG. 8 shows the side hole drill entering the puck light recess hole. The adjustable LED puck light drill jig 10 is secured to edge 19 of the cabinet 100 with clamps 90 and 91. The bottom plate 50 shows drill guide 74 with a drill 94 being inserted into the drill guide 74. The drill guide 74 ensures that the drill 94 creates a hole parallel to the surface of the cabinet 100 and into the center of the center hole 22 of the hole guide 20. Once the drill 94 enters the recessed opening for the puck light the adjustable LED puck light drill jig 10 can be removed for use in another location or the clamp arm 33 can be loosened to reposition the hole guide on the guide rail 40 to a location of the another recessed lighting hole.

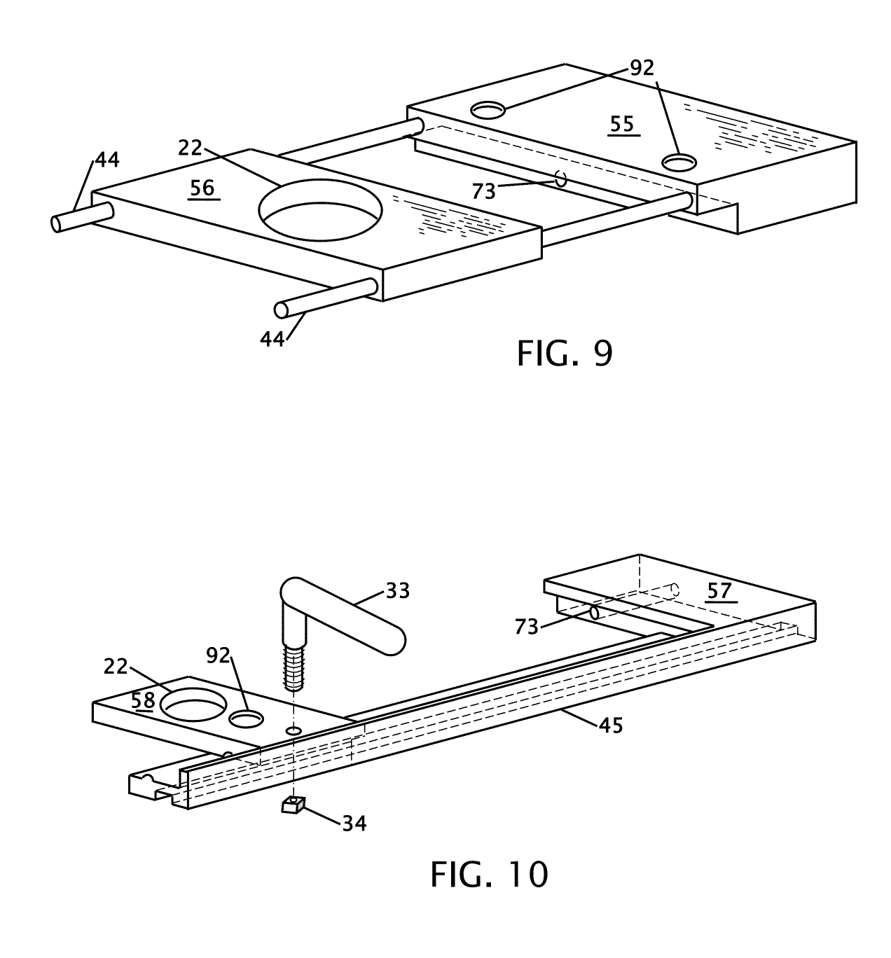

FIG. 9 shows a perspective view of a second preferred embodiment of the adjustable LED puck light drill jig. The jig has two plates 55 and 56 that are secured to a cabinet shelf or wall. Depressions 92 provides a location for clamping the jig onto a shelf or wall. Plate 56 slides on rods 44 to locate the hole 22 for drilling a central hole with a forstner bit. Drill guide 73 provides a guide hole for drilling the hole for wiring. While this embodiment shows two rods 44, it is contemplated that only one or more than two rods can be used.

FIG. 10 shows a perspective view of a third preferred embodiment of the adjustable LED puck light drill jig. The jig has a fixed plate 57 that mounts to one side of a shelf or wall. Drill guide 73 provides a guide hole for drilling the hole for wiring. A side rail 45 provides a guide for movable plate 58 that can be moved along rail 45 to position the location of the hole 22. An arm 33 is turned to clamp through plate 58 and rail 45 to nut 34 to maintain the position of plate 58 relative to plate 57. A recess 92 is used to locate a clamp to hold the jig on a shelf or wall.

Thus, specific embodiments of an adjustable LED puck light drill jig have been disclosed. It should be apparent, however, to those skilled in the art that many more modifications besides those described are possible without departing from the inventive concepts herein. The inventive subject matter, therefore, is not to be restricted except in the spirit of the appended claims.

1. An adjustable LED puck light drill jig comprising:
an adjustable guide rail;
said adjustable guide rail having an adjustment mechanism for placement of a counterbore drill guide at a position along said adjustable guide rail;
said counterbore drill guide includes a counterbore hole to counterbore a hole in a shelf or cabinet;
a fixed plate secured to one end of said adjustable guide rail;
said fixed plate having a stepped edge;
said stepped edge locates an edge of said shelf or cabinet;
said fixed plate further having at least one drill guide;
said drill guide having a centerline that aligns said counterbore drill guide to said drill guide, and
whereby said drill guide produces a blind hole in said cabinet or shelf from an outside surface of said cabinet or shelf to said counterbore hole.

2. The adjustable LED puck light drill jig according to claim 1 wherein said adjustable guide rail has an elongated slot for positioning said counterbore drill guide location.

3. The adjustable LED puck light drill jig according to claim 2 wherein said elongated slot is parallel to said drill guide.

4. The adjustable LED puck light drill jig according to claim 2 wherein said counterbore drill guide clamps to said adjustable guide rail with a threaded fastener.

5. The adjustable LED puck light drill jig according to claim 4 wherein said threaded fastener has a handle or arm.

6. The adjustable LED puck light drill jig according to claim 1 wherein said that includes at least two drill guides.

7. The adjustable LED puck light drill jig according to claim 1 wherein said at least two drill guides are replaceable or changeable with inside diameters.

8. The adjustable LED puck light drill jig according to claim 1 wherein said counterbore drill further includes a guide stop.

9. The adjustable LED puck light drill jig according to claim 8 wherein said guide stop sets a depth for penetration of said counterbore drill into said shelf or wall.

10. The adjustable LED puck light drill jig according to claim 9 wherein said depth for penetration aligns with said drill guide.

11. The adjustable LED puck light drill jig according to claim 8 wherein said guide stop fits around a forstner drill bit.

12. The adjustable LED puck light drill jig according to claim 8 wherein said guide stop is larger in diameter from said counterbore drill.

13. The adjustable LED puck light drill jig according to claim 8 wherein said guide stop is made from acetal.

14. The adjustable LED puck light drill jig according to claim 1 wherein said counterbore drill guide includes indicia for locating said counterbore hole.

15. The adjustable LED puck light drill jig according to claim 1 wherein said drill guide is replaceable.

16. The adjustable LED puck light drill jig according to claim 1 wherein said step in said stepped plate positions said drill guide in a middle of said shelf or wall.

17. The adjustable LED puck light drill jig according to claim 1 wherein said step is parallel to an underside of said counterbore drill guide.

18. The adjustable LED puck light drill jig according to claim 1 wherein said drill guide is clampable onto said cabinet or shelf.

19. The adjustable LED puck light drill jig according to claim 1 wherein said counterbore drill diameter equates to an outside diameter of a puck light.

20. The adjustable LED puck light drill jig according to claim 1 has more than one adjustable guide rails.
